(19) United States
(12) Patent Application Publication
(10) Pub. No.: US 2016/0151758 A1
(43) Pub. Date: Jun. 2, 2016

(54) MICROMOLECULAR CLUSTER WATER PREPARATION METHOD AND MICROMOLECULAR CLUSTER WATER PREPARATION DEVICE USING SAME

(71) Applicants: Zhennan LI, Foshan, Guangdong (CN); Zhenlian LI, Foshan, Guangdong (CN)

(72) Inventors: Zhennan LI, Foshan, Guangdong (CN); Zhenlian LI, Foshan, Guangdong (CN)

(21) Appl. No.: 14/903,481

(22) PCT Filed: Jul. 8, 2014
(86) PCT No.: PCT/CN2014/081841

§ 371 Date: Jan. 7, 2016

(30) Foreign Application Priority Data
Jul. 9, 2013 (CN) 201310286150.9

(51) Int. Cl. B01J 19/08

(52) U.S. Cl. CPC B01J 19/088; B01J 2219/0833; B01J 2219/0854

(57) ABSTRACT

The present invention discloses a micromolecular cluster water preparation method, firstly providing a metal ring having electric discharge holes into the water to be treated; then applying an alternating magnetic field to the side of the metal ring, thus the electric discharge phenomenon occurs by the electric discharge hole of the metal ring, so as to disintegrate the large molecular cluster of the water into the micromolecular cluster. Meanwhile, also disclosed a micromolecular cluster water preparation device using the above method comprises: a non-magnetic conductor container filled with the water to be treated; a metal ring; and a alternating magnetic excitation coil; wherein the metal ring is positioned in the non-magnetic conductor container and has electric discharge holes, the alternating magnetic excitation coil is provided at the outside of the non-magnetic conductor container which is located at the side of the metal ring, so as to apply the alternating magnetic field to the side of the metal ring. The present invention simplifies the prior preparation method, shortens the preparation period, and has a simple structure. The obtained micromolecular cluster water has a low half-peak width value of the ¹⁷O NMR, stable property, delicate tastes and high solubility. The present application may effectively reduce the production cost of the micromolecular cluster water, and have advantages to the promotion of industrial applications.

### FIELD OF THE INVENTION

The present invention relates to the field of preparing micromolecular cluster water, specifically, to a micromolecular cluster water preparation method and micromolecular cluster water preparation device using the same.

### BACKGROUND OF THE INVENTION

Currently, in the wide field of chemical and physical industries, more and more attention has been paid to the micromolecular cluster water as raw material for production since the micromolecular cluster water is smaller than the normal water molecular cluster, has a better solubility as solvent and a better penetrability. In particularly, in the field of cosmetic and industrial gasoline, a great effort has been made to research a convenient, simple preparation method for the micromolecular cluster water. However, the methods for disintegrating the large water molecular cluster into micromolecular cluster are often very complicated, e.g., most of them have tens of steps during which various chemical raw materials and equipment are needed, so that the process of the preparation is complicated and the structure of the apparatus for preparing the micromolecular cluster water is more complicated as well. Furthermore, the higher cost thereof causes the price of the industrial product derived from the micromolecular cluster water is highly either, thus it is difficult to be widely accepted by the consumer and the promotion of the application is suppressed largely.

### SUMMARY OF THE INVENTION

For overcoming the deficiencies of the prior art, the object of the invention is to provide a micromolecular cluster water preparation method with simple process, simple structure, high magnetic effect and a lower cost, and to provide a micromolecular cluster water preparation device using the same.

The object of the invention is achieved by such solution: a micromolecular cluster water preparation method, the preparation method comprises: first providing a metal ring having electric discharge holes into the water to be treated; then applying an alternating magnetic field to the side of the metal ring, thus the large water molecular cluster disintegrates into micromolecular cluster due to the electric discharge phenomenon occurred in the electric discharge hole of the metal ring; an alternating magnetic excitation coil for generating an alternating magnetic field is provided at the outside of the non-magnetic conductor container which is located at the side of the metal ring and is filled with the water to be treated, so as to apply the alternating magnetic field to the side of the metal ring.

Based on the above, the metal ring in the preparation method preferably is an open metal ring with a head end and a tail end, alternatively, the metal ring in the preparation method is a closed metal circle ring.

Further, a cover is provided at the upper cross-section and/or the lower cross-section of the metal ring, and the electric discharge holes may be provided on the cover.

Wherein, a device for applying the above method to prepare micromolecular cluster water comprises a non-magnetic conductor container filling with water to be treated, a metal ring, and an alternating magnetic excitation coil; wherein the metal ring is positioned in the non-magnetic conductor container, and the metal ring has electric discharge holes, the alternating magnetic excitation coil is provided at the outside of the non-magnetic conductor container which is located at the side of the metal ring, so as to apply the alternating magnetic field to the side of the metal ring.

The metal ring according to the device for preparing micromolecular cluster water is an open metal circle ring or a closed metal circle ring.

Further, an cover is provided at the upper cross-section and/or the lower cross-section of the metal ring, and the electric discharge holes may be provided on the cover.

Based on the above, it is preferably that the shape of electric discharge hole can be circular, square or oval.

Based on the above, it is preferably that the metal ring is attached to the inner side wall of non-magnetic conductor container.

Based on the above, it is preferably that a support for fixing the alternating magnetic excitation coil is provided on the outside of the non-magnetic conductor container.

Based on the above, it is preferably that alternating magnetic excitation coil is attached to the outer side wall of non-magnetic conductor container.

The present invention has the follow advantage of effectively simplifying the preparation method, shortening the work period and improving the work efficiency, by first providing a metal ring have electric discharge holes into the water to be treated; then applying an alternating magnetic field to the side of the metal ring, thus the large water molecular cluster disintegrates into micromolecular cluster due to electric discharge phenomenon occurred in the electric discharge holes of the metal ring. Furthermore, the device for performing the method according to the present invention has a simple configuration with an integrative structures of the non-magnetic conductor container filled with water to be treated, the metal ring positioned in the non-magnetic conductor container, and the alternating magnetic excitation coil for applying the magnetic field, so as to disintegrate the large water molecular cluster into micromolecular cluster. The half-peak width value of the ¹⁷O NMR of the obtained water sample is low, the property of the micromolecular cluster water is stable, and the obtained water has delicate tastes and high solubility. The present application may effectively reduce the production cost of the micromolecular cluster water, and have advantages to the promotion of industrial applications.

### BRIEF DESCRIPTIONS OF THE DRAWINGS

FIG. 1 is a structural schematic view of an embodiment of the invention.

FIG. 2 is an expanded schematic view of the metal ring of an embodiment of the invention.

FIG. 3 is a vertical view of an open metal ring according to an embodiment of the invention.

FIG. 4 is a vertical view of a closed metal circle ring according to an embodiment of the invention.

### DESCRIPTION OF THE PREFERRED EMBODIMENTS

Hereinafter the present invention will be described in detail in conjunction with the accompanying figures.

Referring to FIG. 1 to FIG. 4, the micromolecular cluster water preparation method comprises: first providing a metal ring 1 having electric discharge holes 2 into the water to be treated; then applying an alternating magnetic field to the side of the metal ring 1, thus the large water molecular cluster disintegrates into the micromolecular cluster due to the electric discharge phenomenon occurred by the electric discharge hole 2 of the metal ring 1; the alternating magnetic excitation coil 4 generating an alternating magnetic field is provided at the outside of the non-magnetic conductor container 3 which is located at the side of the metal ring and is filled with water to be treated, so as to apply the alternating magnetic field to the side of the metal ring 1. The present preparation method may simplify the production procedure, shorten the production period, and improve the production efficiency.

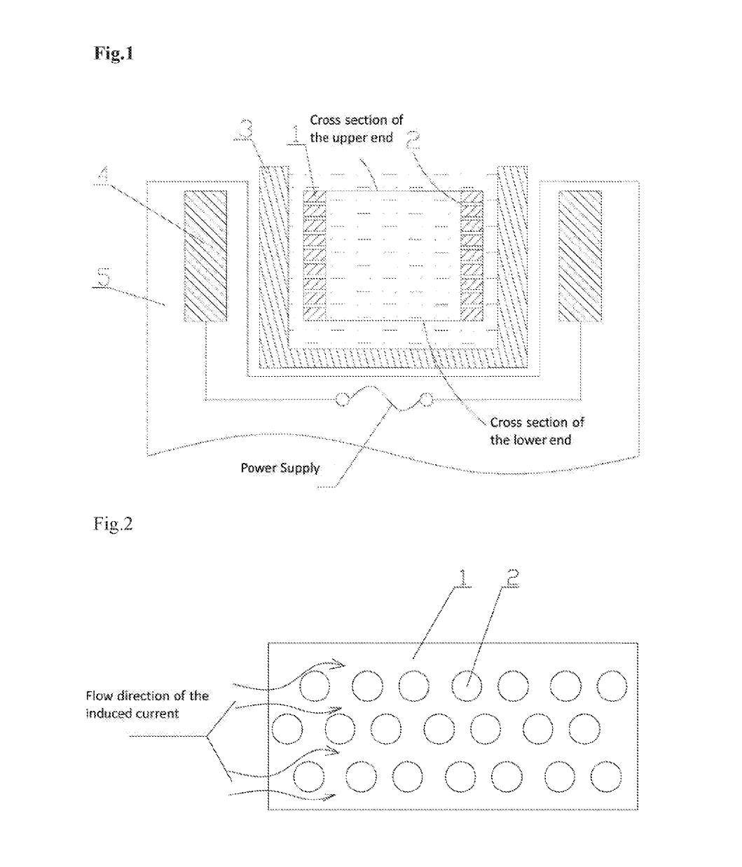

According to the above preparation method, it is preferably that the metal ring 1 is an open metal ring a head end and a tail end, there is a positive and negative potential difference between the head end and the tail end of the open metal ring, so that a circumferential induced current along the ring can be formed, the circumferential induced current may generate a current flow direction radially crossing the electric discharge hole 2 as shown in FIG. 2, thus, the electric discharge phenomenon of the electric discharge hole 2 can be more obvious. Alternatively, the metal ring 1 of the preparation method can be a closed metal circle ring, there is a positive and negative potential difference between the inner and outer surfaces of the ring, the induced current flow from one side to the other side of the ring. The induced current axially across the electric discharge hole 2, thus may also produce an electric discharge phenomenon. In one hand, a closed metal circle ring is preferred for the metal ring 1 of the preparation method according to the practical application; in the other hand, an open metal ring has a better electric discharge effect of the electric discharge holes since when applying a magnetic field, a potential difference around the open metal ring is greater than a potential difference between the top and bottom of the closed ring.

Among them, an cover is provided at the upper cross-section and the lower cross-section of the metal ring 1, and the electric discharge holes 2 may be provided on the cover, thus the electric discharge phenomenon can occur simultaneously at the upper and lower cross-section of the metal ring 1, therefore, a stereo discharge phenomenon can be achieved in the space defined by the inner side surface and the upper and lower end cross-section, which accelerates the process of disintegrating the large water molecular cluster into the micromolecular cluster. The position of the upper cross-section and the lower cross-section are as shown in FIG. 1, wherein the cover is omitted. Alternatively, the cover can be provided only to have the function as a simple cover without the electric discharge holes 2.

The testing report of the micromolecular cluster water obtained by the above micromolecular cluster water preparation method is as follows:

| testing item | mg/L | testing item | mg/L | testing item | mg/L | testing item | mg/L |
|---|---|---|---|---|---|---|---|
| sodium | 3.912 | potassium | 1.180 | calcium | 19.18 | boron | 0.301 |
| magnesium | 2.206 | pH value | 7.66 | Fe2+/Fe3+ | <0.010 | silver | <0.010 |
| selenium | <0.010 | mercury | <0.010 | cadmium | <0.010 | barium | 0.010 |
| cobalt | <0.010 | vanadium | <0.010 | molybdenum | <0.010 | manganese | <0.010 |
| nickel | <0.010 | lead | <0.010 | zinc | <0.010 | chromium | <0.010 |
| lithium | <0.020 | copper | 0.010 | arsenic | <0.010 | phenol | <0.002 |
| | | | | | | compound | |
| strontium | 0.04 | total | 166.6 | nitrite | <0.005 | cyanide | <0.010 |
| | | dissolved | | | | | |
| | | solids | | | | | |
| oxygen | <3.00 | silicon | 11.32 | total colony | <5 CFU/ | Escherichia | 0 (per |
| consumption | | (calculated in | | number | ML | coli | 100 ML) |
| | | metasilicic | | | | | |
| | | acid) | | | | | |

| | |
|---|---|
| half-peak width value of the ¹⁷O NMR | 54 HZ (micromolecular cluster water) |

(Note:
The above test data are from Fudan University Analyzing and Testing Center, the Test Report Number: 13070305)

From the above testing report, it can be seen that: 1. The micromolecular cluster water with a parameter of half-peak width value of the ¹⁷O NMR of 54 HZ is prepared. With respect to the prior water testing repot in the world, when the half-peak width value of the ¹⁷O NMR is small to 80 HZ, it is considered as a stable micromolecular cluster water in physical state. Thus, the water sample obtained by the above method is very stable micromolecular cluster water. 2. The total dissolved solids content of the micromolecular cluster water obtained by the method is 166.6 mg/L. [Note: The relationship of the amount of total dissolved solids and the drinking water taste: excellent (less than 300 mg/L; good (300˜600 mg/L); normal (600˜900 mg/L); bad (900˜1200 mg/L); undrinkable (greater than 1200 mg/L)]. This indicates that the water has a good taste, is very delicate, and has the characteristics of micromolecular cluster water. 3. The water samples were regular tap water before dealing with the present method, the total dissolved solids content of the regular tap water tends to be low value, i.e. <100 mg/L. However, the total dissolved solids content of the micromolecular cluster water obtained by the method is 166.6 mg/L. Thus it can be seen that the solubility of micromolecular cluster water obtained by the method improved greatly, also complying with the high solubility characteristics of the micromolecular cluster water.

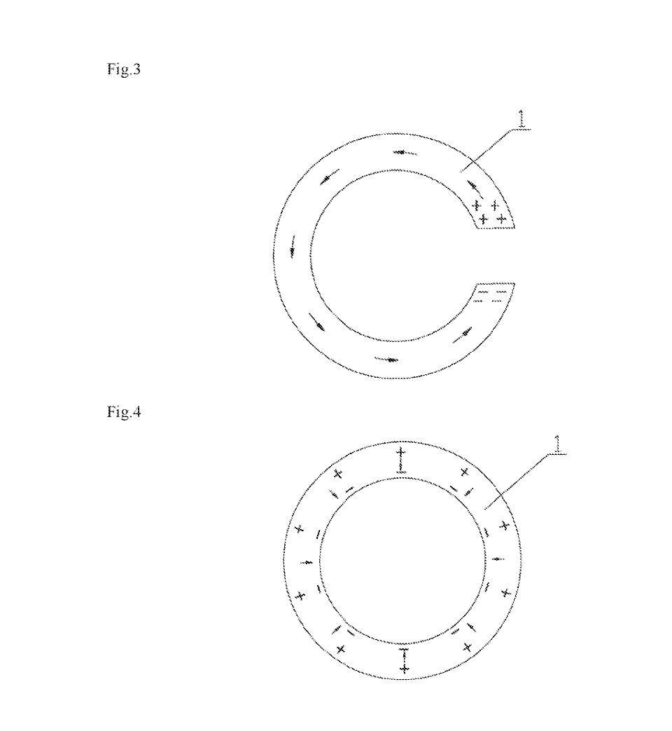

However, referring to FIG. 1 to FIG. 4, a micromolecular cluster water preparation device applying the micromolecular cluster water preparation method comprises: a non-magnetic conductor container 3 filled with water to be treated, a metal ring 1, and a alternating magnetic excitation coil 4, wherein the metal ring 1 is positioned in the non-magnetic conductor container 3, and the metal ring 1 has electric discharge holes 2, the alternating magnetic excitation coil 4 is provided at the outside of the non-magnetic conductor container 3 which is located at the side of the metal ring 1, so as to apply the alternating magnetic field to the side of the metal ring 1. Wherein, the metal ring 1 may be provided as an open metal ring as shown in FIG. 3, there is a positive and negative potential difference between both ends of the open metal ring, so that a circumferential induced current along the ring can be formed on the arrow direction as shown in the figure, the circumferential induced current has a current flow direction radially crossing the electric discharge hole 2 as shown in FIG. 2, thus, the electric discharge phenomenon of the electric discharge hole 2 is more obvious. Alternatively, the metal ring 1 may be provided as a closed metal circle ring as shown in FIG. 4, there is a positive and negative potential difference between the inner and outer surfaces of the ring, the induced current flows from one side to the other side of the ring as shown in the arrow direction in the figure. The induced current axially across the electric discharge hole 2, thus may also produce an electric discharge phenomenon. When the metal ring 1 has a potential difference by applying an alternating magnetic field, the positive charges will be directly transferred to the water molecules from the metal ring 1 with a potential difference through the electric discharge hole 2, thus disintegrating the large water molecular cluster into micromolecular cluster, so as to achieve preparing the micromolecular cluster water from the regular water. According to the practical requirement, the shape of the plurality of electric discharge holes 2 may be circular, square, oval and so on.

Among them, a cover is provided at the upper cross-section and/or the lower cross-section of the metal ring 1, and electric discharge holes 2 may be provided on the cover, thus the electric discharge phenomenon may occur simultaneously between the upper and the lower cross-section of the metal ring 1, so as to realize a stereo discharge phenomenon in the space defined by the sides and the upper and lower end cross-section, which accelerates the procedure of large molecular cluster water converting to the micromolecular cluster water. The position of the upper cross-section and the lower cross-section are as shown in FIG. 1, wherein the cover is omitted. Alternatively, no electric discharge holes 2 are provided on the cover, thus the cover only function as a cap.

Based on the above preparation device, it is preferably that the metal ring 1 is attached to the inner side wall of non-magnetic conductor container 3, the outside of the non-magnetic conductor container 3 is provided with a support 5 for fixing the alternating magnetic excitation coil 4, and the alternating magnetic excitation coil 4 is attached to the outside wall of non-magnetic conductor container 3.

According to the practical application, the configuration manner of the metal ring 1 and the alternating magnetic excitation coil 4 can be on selected from the following group: 1). The metal ring 1 is placed freely inside of a non-metallic container, and the alternating magnetic excitation coil 4 is attached to the outside wall of non-magnetic conductor container 3. 2). The metal ring 1 is placed freely inside of a non-metallic container, and the alternating magnetic excitation coil 4 is fixed on the support 5. 3) The metal ring 1 is attached to the inside wall of non-magnetic conductor container 3, and the alternating magnetic excitation coil 4 is attached to the outside wall of non-magnetic conductor container 3. 4) The metal ring 1 is attached to the inside wall of non-magnetic conductor container 3, and the alternating magnetic excitation coil 4 is fixed on the support 5. The preferred embodiment of the present invention is that the metal ring 1 is placed freely inside of a non-metallic container, and the alternating magnetic excitation coil 4 is fixed on the support 5. As shown in FIG. 1, the metal ring 1 completely contacts the water in the non-magnetic conductor container 3, so as to effectively avoiding the decreasing of the strength of the induced magnetic field between the alternating magnetic excitation coil 4 and the metal ring 1, thus the magnetic field effect can be effectively improved.

That is, the specific operating principle of preparation device applying the micromolecular cluster water preparation method is as follows: firstly positioning the metal ring 1 into the water in the non-magnetic conductor container 3; then applying the alternating magnetic field, in detail, the regular method is to convert an alternating current under a frequency of 220V, 50 HZ to an alternating current under a superaudio frequency of 1500V, 25000 HZ by using a high power electronic oscillation circuit; then generating an alternating electromagnetic field having an ultrasonic vibration effect by using the alternating magnetic excitation coil 4 according to the Faraday's law. The magnetic field lines penetrate the non-magnetic conductor container 3, so that a strong induced loop current occurs on the surface of the metal ring 1 to form a relative strong electrical potential difference. And the induced loop current on the surface fracture of the metal ring 1 forms an instantaneous polar battery effect under the action of the plurality of electric discharge holes 2 provided on the metal ring 1, thus the positive charge is directly transferred to the oxygen ions O₂⁻ of the water molecule, and the negative charge is directly transferred to the hydrogen ions H⁺ of the water molecule. The water molecule is electrolyzed to generate a small amount of substances such as O₂, H₂, HO₂, O₃, H₂O₂ etc. by the electrical energy. Meanwhile, the water in non-magnetic conductor container 31 suffers an excitation magnetization treatment by the alternating magnetic field lines having an ultrasonic frequency, so as to change the angle of the chemical bond of hydrogen and oxygen H-O in the water molecule H₂O from 105° (which correspond to the regular water) into 103°, thus generating micromolecular cluster water.

The micromolecular cluster water prepared by the above micromolecular cluster water preparation device improves the penetrability and solubility 63% relative to that of the large molecular cluster water of ordinary water. For these water molecules, both the surface tension and viscosity decreased; the reducibility increased rapidly, and the oxygen content in water increased significantly. The water molecular cluster state formed thereby reduced from 50-60 H₂O molecular as the ordinary water to 5-10 H₂O molecular, the diameter thereof is less than 2 nm (nanometer), which has the advantageous of a fast moving speed, stronger penetrability and solubility. Further, a large induced loop current is generated on the surface of the metal ring 1, causing the metal molecules of the metal ring 1 vibrating, heating by rapidly friction, thus the harmful elements such as chlorine, fluorine etc. can be removed, achieving the effect of disinfect and sterilization. Thus, based on the overcoming the problem of complexity of the methods for preparing the micromolecular cluster water in the prior art, the present application simplify the structure of the micromolecular cluster water preparation device, greatly reduce the costs, contribute to prepare the micromolecular cluster water with a cheaper production cost.

The above specific embodiments are merely the preferably specific embodiment for the present invention. All the preparation device and preparation method for the micromolecular cluster water with a same or equivalent structure are intended in the protection scope of the present application.

1. A micromolecular cluster water preparation method, wherein, the preparation method comprises: first providing a metal ring having electric discharge hole into the water to be treated; then applying an alternating magnetic field to the side of the metal ring, thus the electric discharge phenomenon occurs by the electric discharge hole of the metal ring so as to achieve the process of disintegrating the large molecular cluster of the water into the micromolecular cluster; the alternating magnetic excitation coil for generating an alternating magnetic field is provided at the outside of the non-magnetic conductor container which is located at the side of the metal ring and is filled with the water to be treated, so as to apply the alternating magnetic field to the side of the metal ring.

2. The micromolecular cluster water preparation method according to claim 1, wherein, the metal ring is an open metal ring or a closed metal circle ring.

3. The micromolecular cluster water preparation method according to claim 2, wherein, a cover is provided at the upper cross-section or/and the lower cross-section of the metal ring, and electric discharge holes are provided on the cover.

4. A micromolecular cluster water preparation device using the method according to claim 1, wherein, the device comprises a non-magnetic conductor container filled with the water to be treated; a metal ring and a alternating magnetic excitation coil; wherein the metal ring is positioned in the non-magnetic conductor container, and the metal ring has electric discharge holes, the alternating magnetic excitation coil is provided at the outside of the non-magnetic conductor containers which is located at the side of the metal ring, so as to apply the alternating magnetic field to the side of the metal ring.

5. The micromolecular cluster water preparation device according to claim 4, wherein, the metal ring is an open metal ring with a head end and a tail end or a closed metal circle ring.

6. The micromolecular cluster water preparation device according to claim 5, wherein, a cover is provided at the upper cross-section or/and the lower cross-section of the metal ring, and electric discharge holes are provided on the cover.

7. The micromolecular cluster water preparation device according to claim 5, wherein, the electric discharge hole has a shape of circular, square, or oval.

8. The micromolecular cluster water preparation device according to claim 7, wherein, the metal ring is attached to the inside wall of non-magnetic conductor container.

9. The micromolecular cluster water preparation device according to claim 8, wherein, a support is provided on the outside of the non-magnetic conductor container for fixing the alternating magnetic excitation coil.

10. The micromolecular cluster water preparation device according to claim 8, wherein, alternating magnetic excitation coil is attached to the outside wall of non-magnetic conductor container.
